(19) United States
(12) Patent Application Publication
(10) Pub. No.: US 2013/0192531 A1
(43) Pub. Date: Aug. 1, 2013

(54) DEVICE FOR DEVELOPING HABITATS IN THE UNDERWATER AREA OF AN OFFSHORE CONSTRUCTION

(71) Applicants: Roland Krone, Bremen (DE); Philipp Kraemer, Hude (DE); Alexander Schroeder, Bremen (DE)

(72) Inventors: Roland Krone, Bremen (DE); Philipp Kraemer, Hude (DE); Alexander Schroeder, Bremen (DE)

(73) Assignee: Stiftung Alfred-Wegner-Institut Fuer Polar-Und Meeresforschung, Bremerhaven (DE)

(21) Appl. No.: 13/699,648

(22) PCT Filed: May 5, 2011
(86) PCT No.: PCT/DE2011/001041

§ 371 Date: Feb. 5, 2013

(30) Foreign Application Priority Data
May 24, 2010 (DE) 10 2010 021 606.2

(51) Int. Cl. A01K 61/00

(52) U.S. Cl. CPC A01K 61/005
USPC 119/200

(57) ABSTRACT

A device for habitat development of marine fauna in an underwater region of an offshore structure having foundations laid in a bed of a body of water includes climbing aids disposed on the offshore structure in the underwater region and at the bed of the body of water. The climbing aids include guide profiles configured to allow vagile hard floor animals to climb the offshore structure that are disposed on the offshore structure, in sections or continuously, in at least one of a vertical, horizontal and diagonal direction.

### CROSS-REFERENCE TO PRIOR APPLICATIONS

This application is a U.S. National Phase application under 35 U.S.C. §371 of International Application No. PCT/DE2011/001041, filed on May 5, 2011, and claims benefit to German Patent Application No. DE 10 2010 021 606.2, filed on May 24, 2010. The International Application was published in German on Dec. 1, 2011, as WO 2011/147400 under PCT Article 21(2).

### FIELD

The invention relates to a device for habitat development of marine fauna in the underwater region of an offshore structure with foundations laid in the bed of a body of water and with climbing aids which are connected to the offshore structure in the underwater region and the bed of the body of water.

### BACKGROUND

Marine fauna, particularly ambulant hard floor animals (“reef animals”), such as for example shrimp, crabs and lobsters, require structured, hard floor substrates, such as for example reefs and stone and shingle fields in their habitat. On soft sand beds, the vagile animals can neither walk nor settle. Harvesting these economically useful animals is therefore out of the question in these regions. The underwater construction of offshore structures, such as for example wind power installations, transformer substations, production platforms, signalling systems, principally constitute an attractive settlement area for numerous hard floor animal species. The designs can however only generally be settled by hard floor animals conditionally with regards to the stability thereof, on account of the purely technically thought out building constructions thereof. The lacking number of hiding possibilities and also lacking holding and climbing options and lowered construction in wide portions of the bed of the body of water often prevent optimal usage of the newly offered, artificial habitat. Increasingly however, this additional usage of offshore structures is used by secondary structural additions for habitat development.

It is known from U.S. Pat. No. 7,476,074B2 to arrange a mariculture cage on the floating body of a wind energy installation. The secondary usage of a wind energy installation for mariculture is described for the first time. In this case, although the floating body is connected to the bed of the body of water with wire ropes or chains, due to the relatively large distance between the bed of the body of water and mariculture cage, this cannot be achieved or can only be achieved for a very low number of hard floor animals.

It is known from WO 01/23253 A1 to configure the concrete foundation of a wind energy installation so porously in terms of the surface structure thereof that marine fauna can settle thereon. Here however, one is concerned more with mussels and not with vagile hard floor animals. Another structure, amended with apertures, is also known from a hollow spherical artificial reef according to U.S. Pat. No. 5,564,369 and U.S. Pat. No. 5,836,265. This reef is however a standalone design and does not make use of available offshore structures. This also applies for a car tyre utilised as habitat according to U.S. Pat. No. 5,807,023, which has pins in its external surface as climbing aids.

Ladder-shaped climbing aids are also known from other technical fields. A rope ladder for tree climbing with a crampon mounting, which clings onto the tree, is for example known from U.S. Pat. No. 5,799,752. A similar ladder for the outboard climbing of a pleasure boat, which is mounted via an eyelet is known from DE 90 11 529 U1.

Climbing aids of this type are not however suitable for marine habitat development for hard floor animals.

US 2006/0170221 A1 describes a device for habitat development (“growth structure”) of marine fauna in the underwater region of an offshore structure with foundations laid in the bed of a body of water is described. The offshore structure is the rotationally symmetrical smooth foundation tower of a wind energy installation. To protect against penetrating water, this is first coated with a protective layer. Above that, the tower is spanned by a net as climbing aid, which serves the settling of Marine fauna, in particular of mussels, but also fish, and reaches down to the bed of the body of water. Mussel occupation is suitable to effectively break impinging waves. The fouling on the tower surface can be used as nourishment, so that by means of the targeted occupation, the inevitably occurring fouling can also be combated. The net can be constructed in such a manner that for harvesting it can be pulled above water by means of a winch. It can however also be securely connected to the tower by means of screws or cotter pins. Harvesting then takes place underwater. Vagile hard floor animals are not however attracted in sufficient numbers by the known device for habitat development.

### SUMMARY

In an embodiment, the present invention provides a device for habitat development of marine fauna in an underwater region of an offshore structure having foundations laid in a bed of a body of water. The device includes climbing aids for vagile hard floor animals, and connected to the offshore structure in the underwater region and to the bed of the body of water. The climbing aids include guide profiles fastened on the offshore structure, in sections or continuously, in at least one of a vertical, horizontal and diagonal direction.

### BRIEF DESCRIPTION OF THE DRAWINGS

Embodiments of the device according to the invention for habitat development of marine fauna in the underwater region of an offshore structure with foundations laid in the bed of a body of water and with climbing aids, which are connected to the offshore structure in the underwater region and the bed of the body of water, are explained in more detail hereinafter on the basis of the schematic figures for the further understanding of the invention. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows the device on an offshore structure,

FIG. 2 shows variations of the guide profile,

FIG. 3 shows variations of the transverse profile,

FIG. 4 shows variations of the circumferential course of the guide profile,

FIG. 5 shows the variation of the one-sided course of the guide profile and

FIG. 6 shows the device on another offshore structure.

### DETAILED DESCRIPTION

In an embodiment, the present invention provides an improved device for habitat development of marine fauna in the underwater region of an offshore structure with foundations laid in the bed of a body of water and with climbing aids which are connected to the offshore structure in the underwater region and the bed of the body of water in a simple manner such that it is also particularly attractive for vagile hard floor animals, so that these animals increasingly also migrate to and live in soft bed regions with offshore structures.

The device according to an embodiment of the invention provides climbing aids for vagile hard floor animals in the form of guide profiles which are fastened on the offshore structure in the vertical, horizontal and/or diagonal direction in sections and/or continuously. With an embodiment of the invention, the vagile hard floor animals can simply reach all underwater heights of the offshore structure, the guide profiles offer protection from cross flows. On the one hand, the animals can settle there, on the other hand they can however also eat the animals (fouling) which are sessile or creep around on the surface of the structure, and thus combat the fouling. According to an embodiment of the invention, the surfaces of the offshore structures, which are generally produced at the factory to be substantially free from projections and steps (“dynamically flat”) in order to reduce fouling, are provided—still in the factory or shortly before installation, if appropriate also in the water after erection as a retrofit—with simple guide profiles, are distinguished and project as accessible ribs into the water space by means of the application thereof. The larger vagile hard floor animals can simply climb on the offshore structure along the guide profiles, in order to hunt and eat there, but also in order to rest their or even live there permanently. Harvesting the attracted hard floor animals can then take place in the conventional manner, for example by means of traps or nets.

Practice has shown that the bed anchoring points of offshore structures in particular, with the relatively high structural complexity thereof and simultaneous proximity to the bed, are heavily settled by crabs and fish.

The device according to an embodiment of the invention here multiplies the offering of spatial alcoves and nests, increases the penetrability of the structure for the vagile animals and by increasing the number of settlement surfaces for aufwuchs organisms, at the same time increases food availability for the animal species. Components which lack a fine structure, such as the connection points above the seabed of a tower for a wind power installation in the form of a tripod, are further improved by means of simple structural additions according to an embodiment of the invention.

The arrangement of the guide profiles is especially adapted to the needs and habits of the vagile hard floor animals to be attracted and can be realised in any desired manner. Vagile hard floor animals move by walking (by contrast with creeping) and are, as they do not swim but rather at best can allow themselves to be carried with the flow, reliant on climbing aids which continuously offer them a hold in order to reach higher heights above the bed of the body of water. The guide profiles in an embodiment of the invention can extend continuously over relatively long paths or in sections, wherein the same are then applied in such a manner that the hard floor animals can make it from one section to the other. In this case, the guide profiles can run vertically, horizontally or even diagonally. An oblique course of the guide profiles simplifies the climbing possibility. However, a vertical guide profile can also readily be climbed by the hard floor animals. Principally, the inclination of the guide profiles is adapted to the course of the offshore structure. This can for example have horizontal, vertical and even diagonal pillars and braces which can be climbed with the guide profiles of the device according to an embodiment of the invention for the hard floor animals as habitat.

It is advantageous in an embodiment of the invention if—in the case of a rotationally symmetrical construction of the offshore structure, for example in the form of a tower or pylon of a wind energy installation—a plurality of guide profiles run parallel on the circumference of the offshore structure in axial and/or radial distribution. A regular, easily installable “bookcase pattern” made up of parallel guide profiles results. Furthermore, the guide profiles can also have a coiled, i.e. circumferential, curved or in some sections straight line course on the circumference of the offshore structure. A climbing aid in the manner of a spiral staircase—with straight sections, so that a polygon results, or continuously curved, constitutes a particularly attractive offering for hard floor animals. Alternatively, planar climbing ring segments can also preferably advantageously be used, the length of which corresponds to a fraction of the circumference of the offshore structure. In order to circle around the structure once, a number of climbing ring segments corresponding to the fraction is required. In this case, the climbing ring segments are arranged obliquely. Between the individual sections, an actual offset may be provided, with which the animals can cope however. To facilitate the climb, small platforms may be provided. For offshore structures with preferably planar surfaces, a one-sided zig-zag-shaped course of the guide profiles can also advantageously be realised. The climbing angle of the guide profiles running in an inclined manner can be chosen in accordance with the desired surface maximisation and desired inclination of the rest surfaces.

The guide profiles can be used in different embodiments. Preferably, the guide profiles can be constructed in the form of ribbed or angled flat profiles or open or closed hollow profiles. Ribbed flat profiles have a rectangular cross-section and stand out on account of a high aspect ratio (small thickness compared to a large width, for example a thickness of 0.5 cm for a width of 5 cm). Angled flat profiles additionally shown an angling, for example a right angle. The hollow profiles can be constructed as closed pipes, so that the cross section thereof already constitutes a barrier for animals starting from a certain size. However, migration on the exterior of the hollow profiles is of course also possible. This is facilitated if the hollow profile is realised in an open manner, for example in the form of a half shell. Common to all guide profiles is the fact that they extend in a ribbed manner from the offshore structure into the water, so that the vagile hard floor animals find a hold thereon and can climb to a height.

In the case of a rotationally symmetrical realisation of the offshore structure, annular guide profiles with radial distribution can preferably be used. Horizontal guide rings around the tower or pillar of the offshore structure result. Preferably, these annular guide profiles can also be openable. This openability can for example be realised by means of a division into two ring halves. The ring halves can then be placed in a simple manner around the tower or pillar and for example be screwed to one another. A design with a hinge and an opposite closure apparatus is likewise possible. For openable annular guide profiles, a realisation in the form of a cuff is useful. To this end, two mutually spaced annular guide profiles are advantageously connected to one another with a net or grate. In this case, the net or lattice (longitudinal lattice or crossed lattice, materials metal, plastic or chalk lattice) can be constructed in sections or also circumferentially. It is also possible for a net to be formed from a lattice with fixed parallel rods, in which lattice parallel wire ropes are woven through bars. By folding around the two annular guide profiles forming the cuff, the tower or pillar is then encompassed by the net or lattice. In the case of a flexible construction of the guide profiles, the cuff can be unrolled around the pillar particularly simply. A particularly narrowly structured habitat field results between the annular guide profiles, which is also very attractive for smaller hard floor animals and other organisms, for example mussels. Harvesting these organisms can then take place in a simple manner by removing the structure cuff with the nets or lattices.

The guide profiles in an embodiment of the invention offer the hard floor animals protection from cross flows and facilitate climbing on the offshore structure. A further facilitation results by means of the advantageous provision of transverse profiles which interrupt the guide profiles at predetermined distances and connect to the offshore structure. These transverse profiles also serve horizontally as paths and simultaneously as rest spots (nests). There, sediments can deposit which shape the surface of the offshore structure so as to promote settlement without further human support. Preferably, the transverse profiles can be produced from metal sheets a few mm thick. If these transverse profiles are produced from lattices however, by contrast species which reject a sediment coating are supported. By means of a plurality of guide profiles and/or transverse profiles applied in parallel, hiding options, hollow honeycombs which offer protection from flows and predators, are created. Overall, the guide profiles and the transverse profiles enlarge the surface of the offshore structure. As a result the settlement area increases also for sessile and creeping animals. Thus the additional food offering increases for the animals increasingly taking up space. Advantageously, transverse profiles can be deposited on the guide profiles only on one side. They can however also be deposited on both sides, so that a doubling of the alcoves results, which makes sense in particular in the case of a vertical arrangement of the guide profiles. At the same time, the transverse profiles are also used, depending on size and realisation, as barriers for a different animal species, as they attach to the structure and cannot be bypassed. To this end, it is advantageous if the side of the transverse profiles projecting into the water has a shape adapted to the animal species to be held back, this can relate on the one hand to the width of the transverse profiles: these may be just as wide as the guide profiles are tall. There may however also be narrower, so that a narrow web of the guide profile leads past the transverse profile and allows correspondingly small animals through. Furthermore, flat transverse profiles—in the manner of a thin metal sheet—can advantageously reconstructed in a triangular manner or have a bevelled corner opposite the alcove formed. Generally, the permeability of the overall device according to an embodiment of the invention can be interrupted by means of the transverse profiles in a targeted manner. “Bottlenecks” can also be formed by means of the transverse profiles, which e.g. constitute impassable locations for very large crabs (edible crabs). As a result, it is possible to act in a controlling manner on the biotic community up to a certain extent (large animals remain in the lower structure region, smaller animals can reside in the upper structure region relatively undisturbed and reproduce there for example).

Depending on the use case guide profiles and transverse profiles can consist of different materials, for example advantageously of steel (flat steel, thickness just a few mm), chalk lattice or plastic, and be used. The steel may be a corrosion-resistant high-grade steel, but also a simple construction steel which is then integrated into a corrosion protection system. Steel has the advantage that it can be welded on easily. Plastic must be screwed on, but is corrosion-resistant and if necessary flexible without further measures over a relatively long period of time. Furthermore, there is also the option to use chalk lattice. If a current is passed through a metal lattice, hard and soft (depending on current intensity) deposits form on the lattice, which are particularly readily accepted by the animals (“Electrochemical Accretion Technology” EAT). In the case of excessive growth, the chalk lattices can also simply be jettisoned by briefly increasing the current flow, so that no manual cleaning measures underwater are required.

It has already been stated above that the device according to an embodiment of the invention can be installed both during production of the offshore structures in the factory, and on land at the installation location and underwater during installation or as a retrofit. In this case, a releasable connection of the guide profiles and/or transverse profiles can advantageously be carried out by means of screwing onto the offshore structure. Better harvesting and cleaning of the device can be achieved in this manner. Alternatively, in the case of offshore structures made of a metal, preferably steel, the device can however also be realised unreleasably by means of welding. This variant can be integrated particularly well in the production of the offshore structures. If the offshore structure has a corrosion protection system, for example in the form of a cathode system, through which a current is passed, the guide profiles and/or transverse profiles—if they are likewise electrically conductive—can easily be integrated into the corrosion protection system present. Also possible however is a standalone corrosion protection system just for the device according to an embodiment of the invention, for example likewise by means of construction as a cathode, through which a current is passed, against a non-conductive structure made from concrete. Other corrosion protection systems, such as for example protective paints can likewise readily be used.

Furthermore, the attractiveness of the device according to an embodiment of the invention with guide profiles can be improved further if advantageously open or closed angled elements or pipe elements with at least one open end made from steel, concrete, glass or plastic are arranged as rest spots on the flat profiles or nets or lattices. These offer additional withdrawal and hiding possibilities for species which rely on cavities in their habitat.

Many offshore structures are placed there on the seabed on a floor panel fixed with tent pegs. Due to the rapidly onsetting scouring, this floor panel quickly floats as a type of barrier up to two metres above the seabed. In order, in such a case to make the device according to an embodiment of the invention accessible to the vagile hard floor animals (such as e.g. the lobsters and large edible crabs) in spite of this, it is advantageous if flexible or rigid connecting elements are provided between the guide profiles and the bed of the body of water. The connecting elements can for example be wire ropes or chains, the rigid connecting elements can for example be formed by a web or a pivotable flap. In this case, the wire ropes or chains are preferably dimensioned to be so long that they follow the scouring and lie on the bed of the body of water for a sufficiently long period. In this case the ends of the wire ropes or chains can also be fixed, for example by means of simple pinning. Optionally, weights can also be integrated, which keep the wire rope or the chain taut. Additionally, blocking elements advantageously constructed in a rod- or disc-shaped manner can be provided on the flexible or rigid connecting elements and/or on the flat profiles, which by means of a particularly narrow arrangement prevent the climbing of certain animal species and sizes.

Furthermore, the guide profiles and/or transverse profiles on the offshore structure can also advantageously simultaneously be used as cable guiding elements for guiding and fixing cables and wire ropes of all types. To this end, guide profiles can be provided for example with special holes.

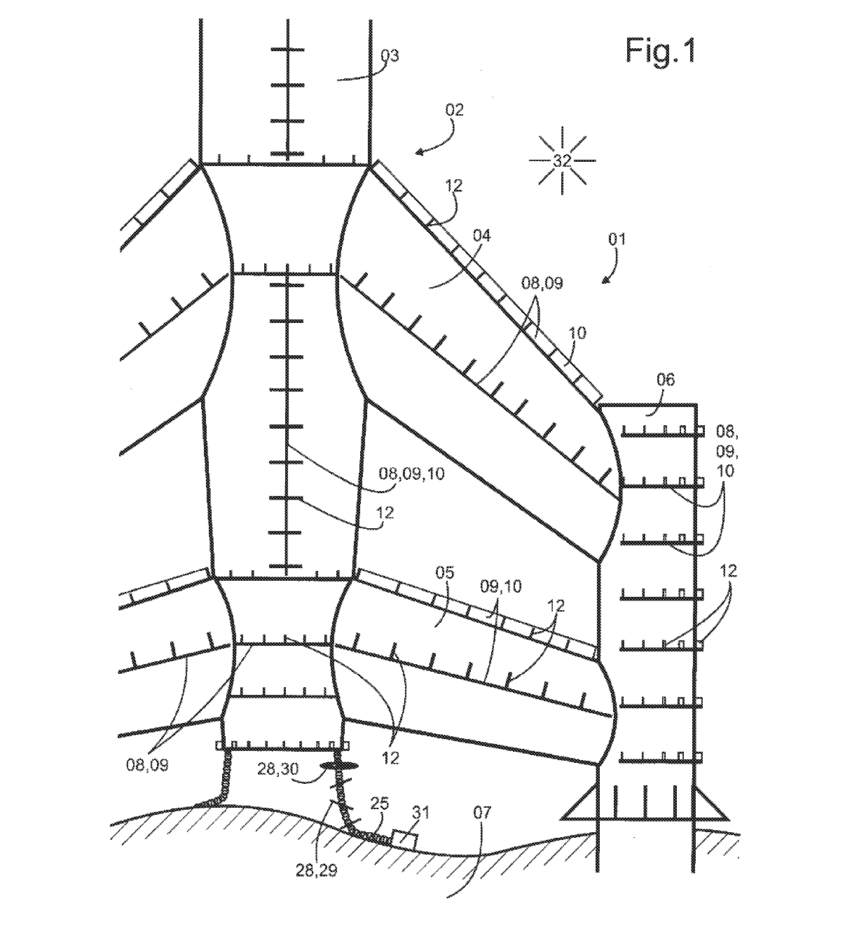

In FIG. 1, a device 01 for habitat development according to an embodiment of the invention on an offshore structure 02 in the underwater region 32 is illustrated. The offshore structure 02 in the exemplary embodiment is a so-called tripod made up of a central pillar 03, three upper support pillars 04 and three lower support pillars 05, which are grounded via base elements 06 in the bed of the body of water 07. The pillars 03, 04, 05 are constructed in a rotationally symmetrical manner. Furthermore, for example a tower for a wind energy installation can be built on the tripod.

The device 01 for habitat development in an embodiment of the invention has special climbing aids 08, which can be used by vagile hard floor animals, for example crabs and lobsters, so that the offshore structure 02 can be climbed for these hard floor animals as additional habitat due to an embodiment of the invention. To this end, the climbing aids 08 are constructed as guide profiles 09. In FIG. 1, one is concerned in this case with simple flat profiles 10, for example made from construction steel, which are welded onto the offshore structure 02. It can be seen that a plurality of rows of guide profiles 09 are arranged extending axially longitudinally or radially circumferentially on the pillars 03, 04, 05 of the offshore structure 02. The course of the guide profiles 09 is preferably adapted to the geometry of the offshore structure 02. In this case, the guide profiles 09 can extend in sections or continuously. In principle, they are attached in such a manner with respect to one another that the hard floor animals can continuously climb the guide profiles 09.

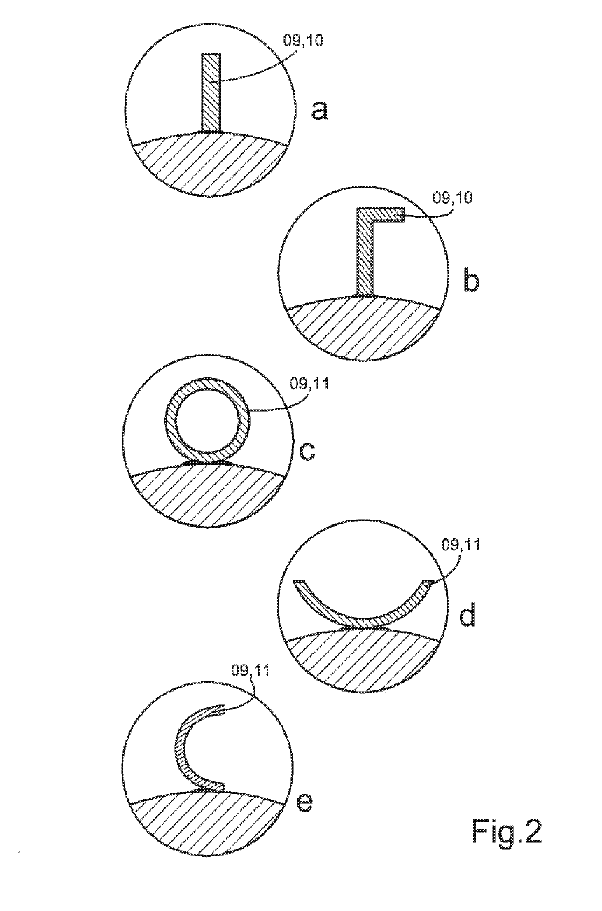

Possible cross sections of the guide profile 09 are illustrated in FIG. 2. Preferably, this is a flat profile 10 with a rectangular cross-section with a large aspect ratio (a), which protrudes in a ribbed manner from the offshore structure into the water (height for example 5 cm). Optionally, the flat profile 10 can also be constructed in an angled manner (b). Alternatively, the guide profile 09 can also be constructed as a hollow profile 11 in closed form (c) or in open form (d, e). Other embodiments are likewise possible, wherein the guide profile 09 must fundamentally have a rib character so that the hard floor animals can climb on the guide profile 09 well.

In FIG. 1, transverse profiles 12 are furthermore illustrated, which divide the guide profiles 09 at predetermined distances and connect the same to the offshore structure 02. These transverse profiles 12 are used for improved climbing and simultaneously as rest spots. Nests can be formed by means of sediment deposits. The transverse profiles 12 can be deposited onto the guide profiles 09 on one side or else on both sides.

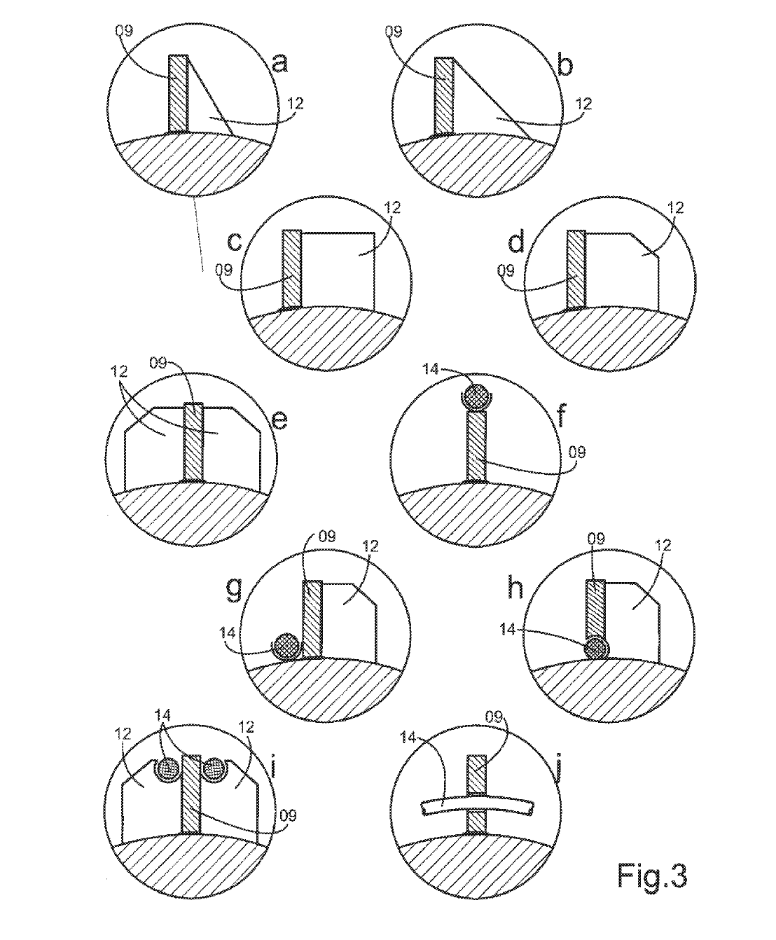

In FIG. 3, possible embodiments of the transverse profiles 12 are illustrated. These can be realised as simple triangular sheets (for example made from metal or plastic) at different inclinations (a), (b). Alternatively, these may be rectangular sheets (c). These may have bevelled corners (d). All examples (a) to (d) show a one-sided deposit of the transverse profiles 12 onto the guide profiles 09. In example (e), a two-sided deposit is illustrated. In FIG. 3, possible additional configurations of the guide profile 09 and the transverse profile 12 as cable guiding elements 13 for cables 14 are furthermore illustrated in the examples (f), (g), (h), (i) and (j).

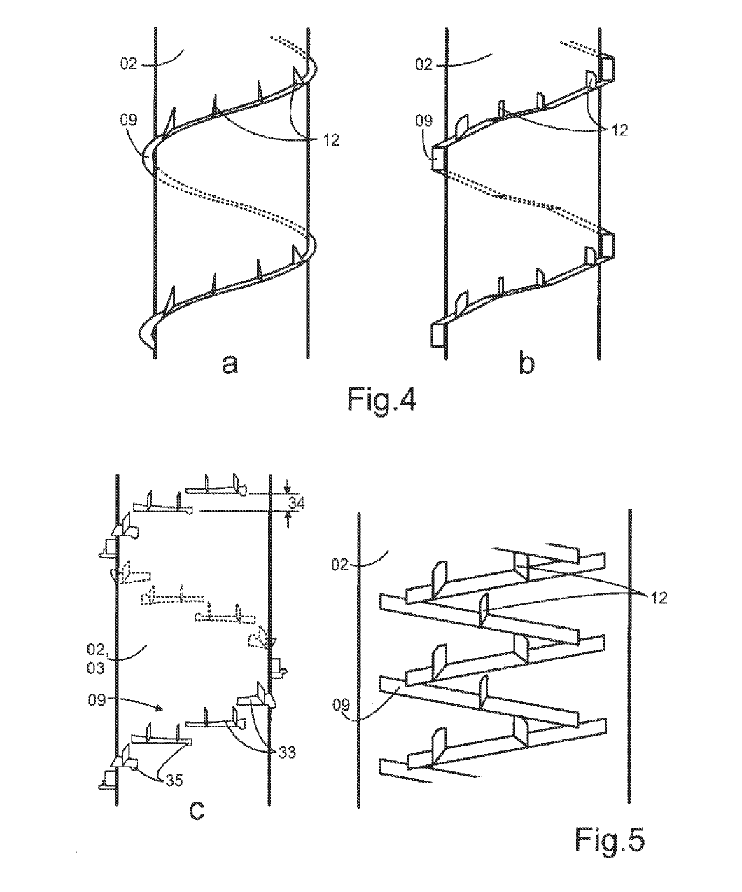

In FIG. 4, climbing orbits of the guide profiles on the offshore structure 02 are illustrated for a rotationally symmetrical construction. The example (a) shows a curved orbit, the example (b) shows an orbit which is straight in sections and enables simple production. In example (c), a variant with planar climbing ring segments 33 as guide profile is illustrated, which has a curvature adapted to the diameter of the offshore structure 02. A climbing ring segment 33 of this type can be produced simply in large quantities and in the case of a realisation in metal (single sheet) easily welded for example onto the central pillar 03. In the case of plastic realisation, adhesive bonding, riveting or screw connection or else a different attachment is possible. The climbing ring segments 33 have a length corresponding to a fraction of the circumference, for example a half, a third or a quarter, of the central pillar 03. Accordingly, two, three or four climbing ring segments 33 are required in order to circle the central pillar 03 once. In this case, the climbing ring segments 33 are arranged with an axial offset 34 with respect to one another, which the animals (or even only animals from a certain size) can overcome when climbing. For facilitation, small platforms 35 can be provided at least at one end of the climbing ring segments 33. FIG. 5 finally shows a zig-zag-shaped course of the guide profiles 09 on an offshore structure 02 with a planar surface. Here, the guide profile 09 can likewise be produced simply in large quantities.

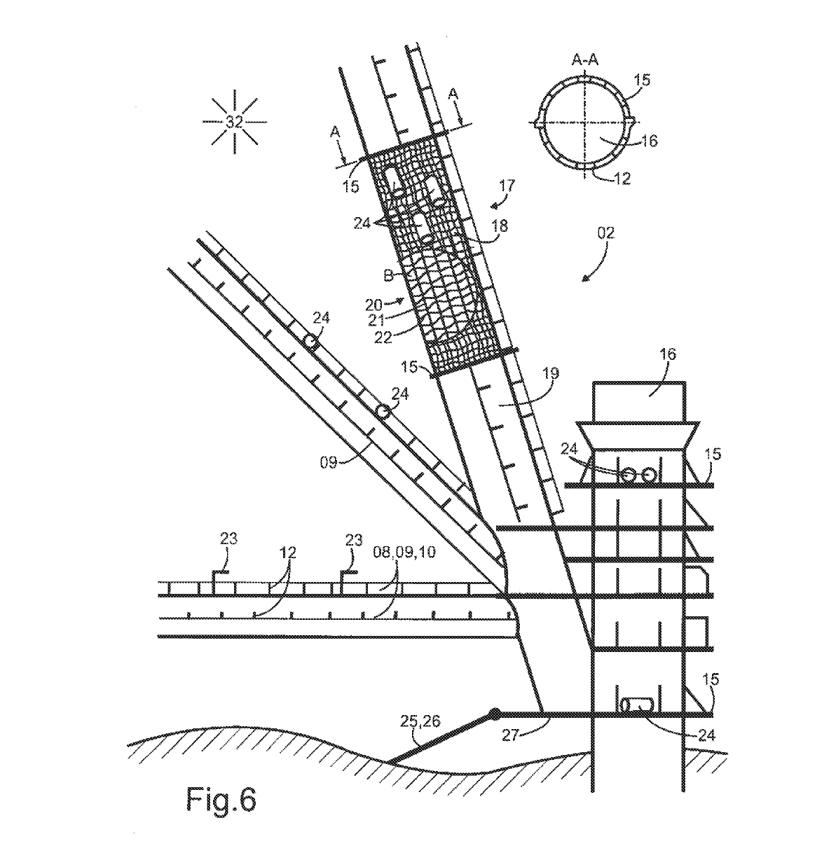

In FIG. 6, a plurality of closed annular guide profiles 15 are illustrated in a plurality of radial planes above one another (here on an offshore structure 02 in the embodiment of a framework). In this case, the annular guide profiles 15 are divided into two sections and are openable (see Section AA), so that for installation they can simply be laid around the round foundation element 16. Furthermore, a structure cuff 17 is illustrated, which consists of two mutually distanced annular guide profiles 15 and a net 18 arranged therebetween. By laying the two guide profiles 15 around a round framework brace 19, the same is surrounded with the structure cuff 17. The net 18 constitutes a particularly fine-meshed habitat region which is also interesting for other marine animals. Harvesting sessile animals is possible simply by removing the structure cuff 17. Instead of the net 18, a lattice 20 made up of lattice rods 21 running between the two annular guide profiles 15 with a wire rope 22 woven in can be used (see Detail B).

Furthermore, additional angled elements 23 and pipe elements 24 are illustrated in FIG. 6, which, as resting and hiding spots, further increase the attractiveness of the device 01 according to an embodiment of the invention. Additionally, FIG. 6 also shows a rigid connecting element 25 in the form of a flap 26. The connecting element 25 is used for the production of a connection between the bed of the body of water 07 and a base plate 27 on the foundation element 16 which has been released by scouring and makes it possible for the vagile hard floor animals to reach the guide profiles 09.

The same is true for a connecting element 25 in the form of a wire rope 27 for the central pillar 03 which itself does not have a connection to the bed of the body of water 07 in FIG. 1, which also comprises blocking elements 28 in the form of rods 29 or disc's 30 for keeping undesired animal species away and a base weight 31 for base fixing. Similar blocking elements 28, for example in the form of a bottleneck can also be arranged on the guide profiles 09 for keeping undesired animal species away.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B.” Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise.

### Reference List

01 Device for habitat development

02 Offshore structure

03 Central pillar

04 Upper support pillar

05 Lower support pillar

06 Base element

07 Bed of a body of water

08 Climbing aid

09 Guide profile

10 Flat profile

11 Hollow profile

12 Transverse profile

13 Cable guiding element

14 Cable

15 Annular guide profile

16 Foundation element

17 Structure cuff

18 Net

19 Framework brace

20 Lattice

21 Lattice rod

22 Wire rope

23 Angled element

24 Pipe element

25 Connecting element

26 Flap

27 Base plate

28 Blocking element

29 Rod

30 Disc

31 Base weight

32 Underwater region

33 Climbing ring segment

34 Vertical offset

35 Platform

1-22. (canceled)

23. A device for habitat development of marine fauna in an underwater region of an offshore structure having foundations laid in a bed of a body of water, the device comprising:
climbing aids for vagile hard floor animals, the climbing aids connected to the offshore structure in the underwater region and to the bed of the body of water, the climbing aids including guide profiles fastened on the offshore structure, in sections or continuously, in at least one of a vertical, horizontal and diagonal direction.

24. The device according to claim 23, wherein the offshore structure has a rotationally symmetric construction and wherein at least some of the guide profiles run parallel to each other in at least one of an axial and a radial distribution on a circumference of the offshore structure.

25. The device according to claim 23, wherein the guide profiles follow a course on a circumference of the offshore structure that is at least one of circumferential, curved and straight.

26. The device according to claim 25, wherein at least some of the guide profiles are curved circumferential guide profiles in a form of identical planar climbing ring segments that are arranged obliquely circumferentially with a vertical offset with respect to one another.

27. The device according to claim 26, further comprising small platforms disposed at least at one end of the climbing ring segments.

28. The device according to claim 23, wherein the off shore structure has a planar construction and wherein at least some of the guide profiles are disposed in a one-sided zig-zag-shaped course on a side of the offshore structure,

29. The device according to claim 23, wherein the guide profiles are at least one of ribbed profiles, angled flat profiles and open or closed hollow profiles.

30. The device according to claim 24, wherein at least some of the guide profiles are closed annular guide profiles in the radial distribution.

31. The device according to claim 30, wherein the closed annular guide profiles are openable.

32. The device according to claim 30, further comprising a net or lattice disposed, in sections or circumferentially, between two mutually spaced ones of the closed annular guide profiles so as to form a structure cuff

33. The device according to claim 23, wherein further comprising transverse profiles which divide the guide profiles at predetermined distances and connect the guide profiles to the offshore structure.

34. The device according to claim 33, wherein each of the guide profiles include a transverse profile on one side or on two sides.

35. The device according to claim 33, wherein each of the transverse profiles are flat and have a triangular shape or a polygonal shape with a bevel on a side facing away from a respective one of the guide profiles.

36. The device according to claim 23, wherein the guide profiles are from steel, chalk lattice or plastic.

37. The device according to claim 23, wherein the guide profiles are releasably connected to the offshore structure via screwing.

38. The device according to claim 23, wherein the offshore structure is metallic and wherein the guide profiles are unreleasably connected to the offshore structure via welding.

39. The device according to claim 23, wherein the guide profiles are integrated into a corrosion protection system of the offshore structure.

40. The device according to claim 23, further comprising at least one of open or closed angled elements and pipe elements with at least one open end made from steel, concrete, glass or plastic disposed on the guide profiles.

41. The device according to claim 23, wherein the climbing aids include flexible or rigid connecting elements disposed between the guide profiles and the bed of the body of water.

42. The device according to claim 41, wherein the flexible connecting elements include at least one of a wire rope and a chain and wherein the rigid connecting elements include at least one of a web and a flap.

43. The device according to claim 23, further comprising blocking elements disposed on the guide profiles in a rod-shaped or disc-shaped manner.

44. The device according to claim 23, wherein at least some of the guide profiles are configured as cable guiding elements.
